(19) United States
(12) Patent Application Publication
(10) Pub. No.: US 2006/0122853 A1
(43) Pub. Date: Jun. 8, 2006

(54) System and method for managing supplier contracts

(76) Inventors: Sandy McLemore, Frisco, TX (US); Diane S. Lee, Newark, OH (US); Elena Rangel, Harlingen, TX (US)

Correspondence Address: BAKER BOTTS L.L.P., 2001 ROSS AVENUE, 6TH FLOOR, DALLAS, TX, 75201, US

(21) Appl. No.: 11/004,224

(22) Filed: Dec. 3, 2004

(51) Int. Cl. G06Q 99/00

(52) U.S. Cl. 705/1

(57) ABSTRACT

According to one embodiment, a method of managing supplier contracts includes receiving a request for assistance on a contract from a requester, the request including a plurality of data, automatically associating a request number with the request, and automatically notifying, based on at least some of the data, a contract lead of the request. The method further includes receiving, from the contract lead, a designation of a negotiator for the request, automatically associating a record number with the request to establish a record, automatically placing the record in a worklist for the negotiator, automatically notifying the negotiator of the record, and automatically notifying the requestor of the designated negotiator. The method may further include determining which contract lead to send a message to based on criteria on the request, and receiving an assignment of the request to members of his/her team.

### TECHNICAL FIELD OF THE INVENTION

This invention relates in general to contract management and, more particularly, to a system and method for managing supplier contracts.

### BACKGROUND OF THE INVENTION

Financial pressures continue to challenge business executives to reduce expenses while generating revenue growth. Procurement decisions, such as purchasing decisions regarding particular suppliers, products, and shipping of purchased products, often have a substantial impact on a business organization's bottom line, providing opportunities for reducing expenses as well as increasing revenue. In addition, such procurement decisions often influence the organization's general operation and the quality of goods or services procured by the organization.

Procurement decisions are often complex and involve the analysis of heterogeneous information, which may be constantly evolving, over a period of time. For example, such information may include large volumes of product data, purchaser (or client) requirements, supplier constraints, legal regulations and contractual terms and obligations. Contractual terms and obligations may originate from contracts between the business organization and its various suppliers. Some business organizations may deal with hundreds or even thousands of suppliers, and may therefore have hundreds or thousands of supplier contracts in negotiation or active at any particular time.

As such, many employees of the business organization, some of whom are scattered across the world, may be seeking to negotiate or negotiating a supplier contract. With no way of knowing what others in the organization are pursuing, problems may arise, such as conflicts of interest, disputes with particular suppliers, and knowing when a particular contact has expired. These, and other problems, stem from the lack of timely information provided to employees of the organization and can be a major source of additional expenses, which hurts the bottom line.

### SUMMARY OF THE INVENTION

According to one embodiment, a method of managing supplier contracts includes receiving a request for assistance on a contract from a requestor, the request including a plurality of data, automatically associating a request number with the request, and automatically notifying, based on at least some of the data, a contract lead of the request. The method further includes receiving, from the contract lead, a designation of a negotiator for the request, automatically associating a record number with the request to establish a record, automatically placing the record in a worklist for the negotiator, automatically notifying the negotiator of the record, and automatically notifying the requestor of the designated negotiator.

Various embodiments of the present invention may benefit from numerous advantages. One or more embodiments may benefit from some, none, or all of these advantages. For example, one advantage is that large business organizations that have a large number of suppliers may have a central repository that houses supplier data, information of all the past and current supplier contracts, and supplier contracts currently being negotiated. In one embodiment, employees in the organization may access this information through a company intranet so that they can gain valuable information on a timely basis so that problems may be avoided, such as duplicity of effort, conflicts of interest, and the like. Up-to-date information on suppliers, current supplier contracts, and pending supplier contracts, may be accessed on a substantially real-time basis to help employees of a company be more efficient and cost-effective in their jobs, which hopefully pads the bottom line. Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example supplier contract management system in accordance with an embodiment of the present invention;

FIG. 2 is a flowchart illustrating a general methodology of managing supplier contracts in accordance with an embodiment of the present invention;

FIG. 3 is a flowchart illustrating an example method of managing supplier contracts in accordance with an embodiment of the present invention; and

FIG. 4 is a flowchart illustrating an example method of managing supplier contracts in accordance with another embodiment of the present invention.

### DETAILED DESCRIPTION OF THE DRAWINGS

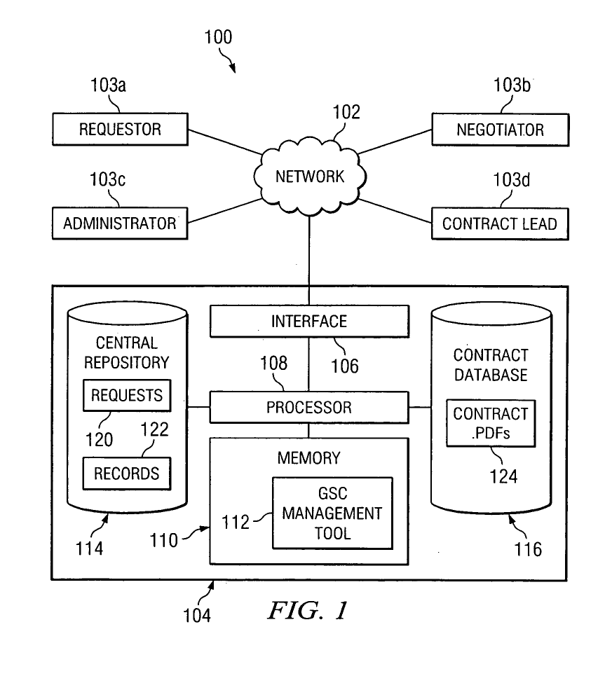

Example embodiments of the present invention and their advantages are best understood by referring now to FIGS. 1 through 4 of the drawings, in which like numerals refer to like parts.

FIG. 1 illustrates an example supplier contract management system 100 in accordance with an embodiment of the present invention. FIG. 1 depicts a simplified block diagram of a service company that does business on a global basis and has numerous suppliers scattered throughout the world. However, the present invention contemplates system 100 being utilized by any suitable entity or entities that utilize suppliers.

Generally, supplier contract management system 100 is a fully integrated, web-based supplier contract management solution. In one embodiment, system 100 enables various employees of a company the ability to store and access supplier contract information electronically throughout the contract life-cycle. System 100 may provide these employees global access to timely and accurate contract information regarding current procurement negotiations, as well as historical procurement negotiations, in order to effectively execute existing contract obligations or influence future procurement activities. System 100 is particularly advantageous for large business organizations that have a large number of suppliers.

In the illustrated embodiment, system 100 includes a network 102 connecting a plurality of employees 103 of a company to a server 104. Network 102 is any suitable communications network that employees 103 utilize for communication between their personal computing device and server 104. For example, network 102 may be a local area network, a wide area network, an intranet, an extranet, a virtual private network, the Internet, or any other suitable public or private network or series of networks.

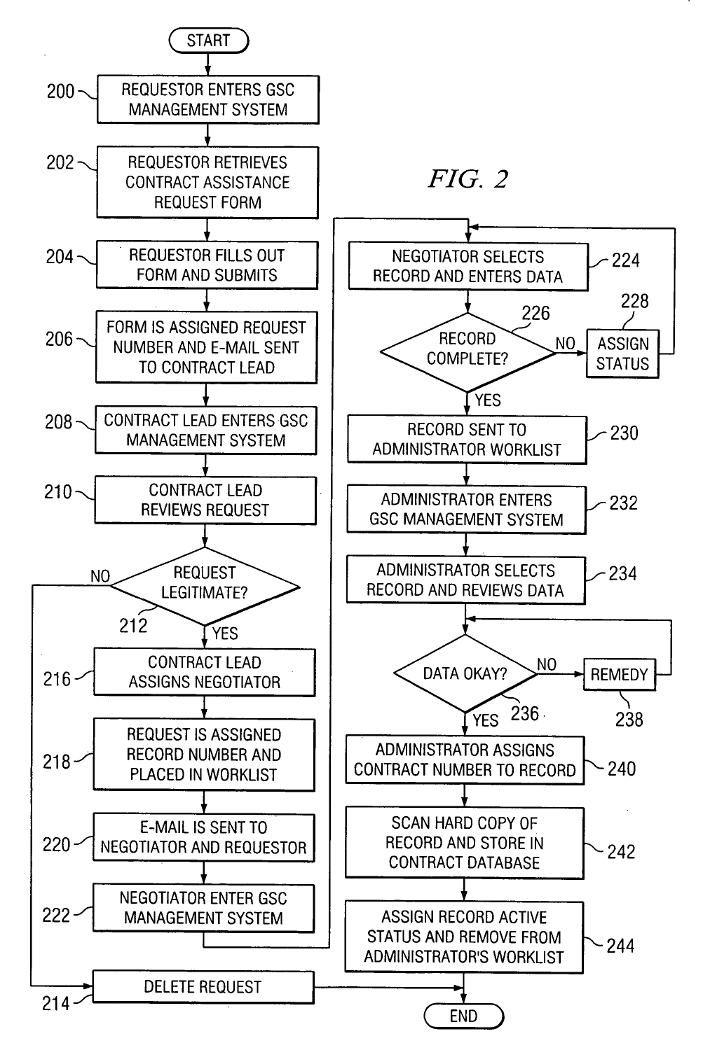

Employees 103 may be any suitable employees utilizing supplier contract management system 100. In the illustrated embodiment, employees 103 are depicted as a requestor 103a, a negotiator 103b, an administrator 103c, and a contract lead 103d. Each of these employees 103 are described in greater detail below in conjunction with FIGS. 2 through 4. Generally, requestor 103a is someone who is requesting assistance on a particular contract or agreement, negotiator 103b is an employee that oversees the negotiation of the contract or agreement, administrator 103c is an employee that provides the assistance for the contract or agreement, and contract lead 103d is an employee who assigns negotiator 103b and/or administrator 103c to a particular request for assistance by requestor 103a.

Although server 104 is discussed herein as being a single server at a single location, the functionality of server 104 may reside across multiple servers residing at any suitable locations. In the illustrated embodiment, server 104 includes an interface 106, a processor 108, a memory 110 storing global supplier contract (“GSC”) management tool 112, a central repository 114 storing requests 120 and records 122, and a contract database 116 storing contract .PDF's 124.

Interface 106 functions to allow server 104 to communicate with other devices and components, such as the personal computing devices of employees 103, in order to transmit and receive information. In one embodiment, interface 106 is a network interface card; however, interface 106 can be other devices suitable for receiving and transmitting signals, such as a modem or a digital subscriber line. Interface 106 may also be operable to allow communications wirelessly.

Processor 108 comprises any suitable processing unit that executes logic. One of the functions of processor 108 is to retrieve GSC management tool 112 from memory 110 and execute the functions of tool 112 based on inputs and data transmitted to server 104. Processor 108 may also control the receiving, storing, and retrieving of information and data in central repository 114 and/or contract database 116. Other suitable functions of processor 108 are contemplated by the present invention. Memory 110 may comprise any suitable organization of volatile or non-volatile memory. Memory 110 may comprise random access memory, read-only memory, CD-ROM, removable memory devices, write access memory, or any other suitable device that allows storage and/or retrieval of data.

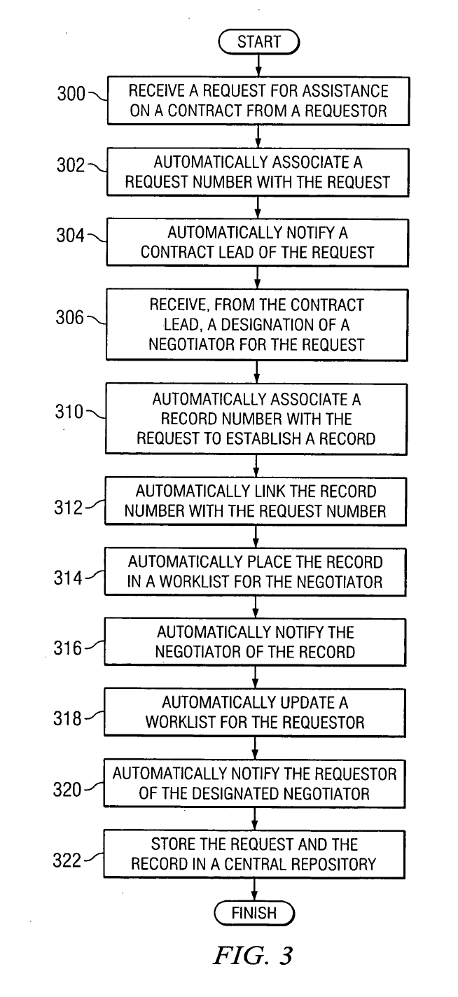

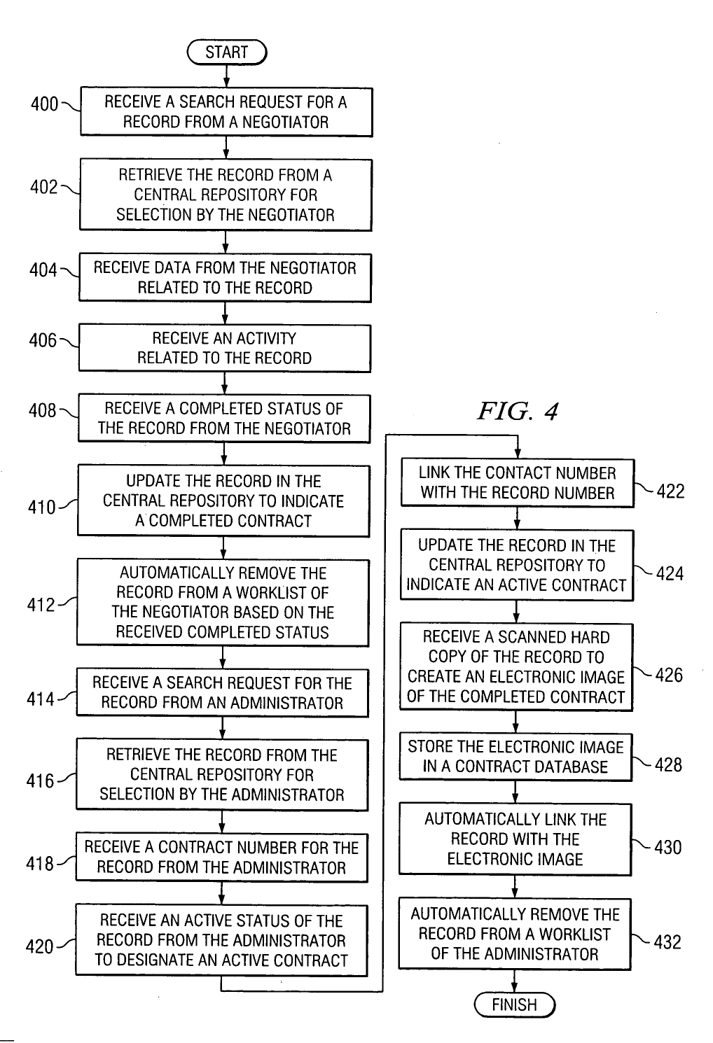

GSC management tool 112 may be any suitable computer program or number of computer programs that are written in any suitable computer language. GSC management tool 112, in one embodiment, is operable to receive information and/or data from one of the employees 103 in order to effectively manage supplier contracts for an entity. Tool 112 may support multiple simultaneous users, such as employees 103, and may be capable of providing entry, query, edit, and append functionality. It may also provide global search and storage capabilities that allow a user to identify and select specific supplier contracts based upon various business requirements, knowledge, and skill level as determined by individual security classification. Example functions of GSC management tool 112 are described below in conjunction with FIGS. 3 and 4. In the illustrated embodiment, GSC management tool 112 is logic encoded in memory 110. However, in alternative embodiments, tool 112 is implemented through application-specific integrated circuits, field programmable data aids, digital signal processors, or other suitable specific or general purpose processors.

Central repository 114 and contract database 116 may comprise files, stacks, databases, or other suitable organizations of volatile or non-volatile memory. Central repository 114 and contract database 116 may be random access memory, read-only memory, CD-ROM, removable memory devices, or any other suitable devices that allow storage and/or retrieval of data. Central repository 114 and contract database 116 are interchangeable and may perform the same functions. In the illustrated embodiment, central repository 114 is storing requests 120 and records 122, both of which are described in greater detail below in conjunction with FIG. 2. Also in the illustrated embodiment, contract database 116 is storing contract .PDF's 124, which represent electronic files associated with executed paper contracts. These are also described in greater detail below.

FIG. 2 is a flowchart illustrating a general methodology of managing supplier contracts in accordance with an embodiment of the present invention. The flowchart of FIG. 2 incorporates some of the functionality of GSC management tool 112 (FIG. 1), but also includes some steps that are performed manually by employees 103.

The example method begins at step 200 where requestor 103a enters supplier contract management system 100. To access system 100, requestor 103a may simply click on an icon on their personal computer that takes them to the home page of system 100. Requestor 103a, as well as other employees 103, may have to obtain permission (e.g., enter a valid user ID and password) in order to access the home page of system 100. As is described above, requestor 103a is one who desires or needs assistance on a contract or agreement with a supplier, or who otherwise needs assistance from a negotiator or other suitable procurement services personnel. As used throughout this detailed description, a “contract” means any suitable contract or agreement, such as a hardware agreement, an evaluation agreement, a non-disclosure agreement, and a beta test agreement.

As indicated by step 202, requestor 103a retrieves a contract assistance request form. This may be done in any suitable manner, such as clicking on a link on the home page, which then displays a blank form. Requestor 103a then fills out the form by populating fields on their computer screen and then submits the form, as indicated by step 204, by clicking on a “submit request” button. Examples of some information that is filled out on the form by requester 103a is the date of the inquiry, the line of business, the country, the industry, the category, requestor information, general nature of the request, supplier information, and other suitable information. In a particular embodiment of the invention, GSC management tool 112 is capable of retrieving an existing request 120 that is stored in central repository 114 and automatically populating the fields of the form with that information.

Once the contract assistance request form is submitted, the form is assigned a request number to establish a request 120 that is stored in central repository 114 and an email is automatically sent to a particular contract lead 103d based on at least some of the information that was input by requestor 103a, as indicated by step 206. For example, particular contract leads 103d may be assigned to a particular country, category and/or industry. Contract lead 103d may also be notified using other suitable methods.

Contract lead 103d may then enter GSC management system 100, as indicated by step 208, to review request 120 submitted by requester 103a, as indicated by step 210. Contract lead 103d first determines whether or not request 120 is legitimate, as indicated by decisional step 212. If request 120 is not legitimate for any suitable reason, the method proceeds to step 214 where request 120 is deleted (removed from central repository 114) and requestor 103a is notified as such. However, if request 120 is legitimate, then contract lead 103d assigns a negotiator 103b to request 120 by selecting a negotiator from a pull-down list, as indicated by step 216. It is preferable that the selected negotiator 103b be assigned to the same team as contract lead 103d. A record number is then automatically assigned to request 120 to establish a record 122 and record 122 is automatically placed in a worklist for negotiator 103b, as indicated by step 218. Record 122 is linked with request 120 by their numbers for future reference and/or searching capabilities. Emails are thereafter automatically sent to both negotiator 103b and requestor 103a to notify each of the designation, as indicated by step 220.

Negotiator 103b may then enter GSC management system 100, as indicated by step 222 to access record 122. Negotiator 103b, in one embodiment, is a member of one or more negotiation teams within an organization that provides contract assistance to employees that need the assistance. Negotiator 103b may also be administrator 103c or contract lead 103d, and vice versa. Negotiator 103b may select record 122 that is assigned to him or her in order to enter particular data associated therewith, as indicated by step 224. Although any suitable information and/or data may be entered by negotiator 103b, in one embodiment, negotiator 103b enters general information, supplier information, company contact information, terms and conditions of the contract, and information related to a document cover sheet. Each of these may be entered using pull-down menus having any suitable number of fields for entering data. Record 122 may be stored in central repository 114 and accessed multiple times by negotiator 103b during the negotiation process. Others may also access record 122 if they have the appropriate access level.

At decisional step 226, it is determined whether or not record 122 is completed. Completed means that the contract or agreement associated with record 122 has been executed and is to be routed to contract administration for processing and filing of such document. If record 122 is not completed, negotiator 228 assigns a status to record 122, as indicated by step 228. Although any suitable statuses may be associated with any particular record, in a particular embodiment of the invention, a record may have the following statuses assigned while negotiator 103b is assigned to the record: assigned, in progress, on hold, canceled, completed, in dispute, and satisfied. “Assigned” means that a record has been assigned to a negotiator and is currently in the worklist of the negotiator. “In progress” means that the negotiator is currently working on the record. “On hold” means that the record is on hold for some suitable reason. “Cancelled” means that a request was received for a negotiator or administrator to perform an activity and for some reason it was determined such activity did not require performance. In this case the record has moved off of the worklist of the negotiator. “In dispute” means that the record is in dispute with a supplier and remains in the worklist of the negotiator. “Satisfied” means that a request for a negotiator or administrator to perform an activity was performed and requestor did receive an answer on their request; however, no document was ever executed. The record is then moved off of the negotiator worklist.

Referring again to decisional step 226, when record 122 is complete, it is automatically removed from the worklist of negotiator 103b and added to the worklist of administrator 103c, as indicated by step 230. The administrator 103c may then enter supplier contract management system 100, as indicated by step 232. As indicated above, an administrator is one who reviews a particular completed contract to make sure that all is in order and that no problems exist with the executed document. Hence, administrator 103c searches for and selects record 122 and reviews the data associated therewith, as indicated by step 234.

At decisional step 236, it is determined whether or not the data associated with the particular record is adequate. If there is something wrong with record 122, then the problems are remedied, as indicated by step 238. When the record 122 is deemed adequate by administrator 103c, he or she is able to assign a contract number to record 122, as indicated by step 240, to establish an active contract. In some embodiments, an active contract is established without the assignment of a contract number. The contract number is automatically linked with the record number and stored in central repository 114. A hard copy of record 122 is then scanned, at step 242, and stored in contract database 116 or other suitable location. Scanning of the hard copy, in one embodiment, creates a .PDF of record 122, for ease of viewing at a later time. Other suitable file formats may also be utilized for capturing the electronic image of record 122. Record 122 is then assigned an active status by administrator 103c, as indicated by step 244, and management tool 112 automatically removes the record from the worklist of administrator 103c, thereby ending the example method illustrated in FIG. 2. It should be noted that the record 122 and .PDF of record 122 are archived and easily retrieved as needed by users with appropriate security access.

Although administrator 103c may assign an active status to record 122, other suitable statuses may be associated with record 122 when it is in the worklist of administrator 103c. For example, according to a particular embodiment of the invention, various statuses that may be associated with record 122 are as follows: active, expired, completed, terminated, and satisfied. “Active” means that the record has been completed in full and the contract is now active; the record is removed off of the worklist of administrator 103c. “Expired” means that the record is now expired for some suitable reason and the record is removed from the worklist of administrator 103c. “Completed” means that the record was completed by negotiator 103b and has been moved to the worklist of administrator 103c. “Terminated” means that no additional products and/or services can be obtained under such contract terms, and is moved off of the worklist of administrator 103c. “Satisfied” means that a request was received for administrator 103c to perform an activity and such activity was performed and requestor received their answer; however, no document was ever executed and the record is moved off the worklist of administrator 103c. Again, it should be noted that the record 122 and a .PDF of record 122 may be archived and easily retrieved as needed by users with appropriate security access.

Although not illustrated in the flowchart of FIG. 2, supplier contract management system 100 may also have functionality to allow requesters, negotiators, administrators, and contract leads to enter activities associated with a particular record, depending on their access level. These activities may be any suitable activities and function as a journal in which notes may be entered regarding things that have happened in the negotiation of the contract or other suitable events that have taken place related to the record in order to keep all parties up to date with current and accurate information. Activities may also be automatically generated by system 100 depending on certain actions made to the record. There may also be search functions associated with supplier contract management system 100, such as being able to search for a particular employee 103 of the company, or to search for particular suppliers, contracts, or other suitable information. Employees 103 may also have the option of customizing particular fields for records 122 to suit their needs.

Also not illustrated in the flowchart of FIG. 2 is that negotiator 103b, administrator 103c, or contract lead 103d (i.e., someone other than requestor 103a ) may initiate their own request 120 utilizing supplier contract management system 100.

FIG. 3 is a flowchart illustrating an example method of managing supplier contracts in accordance with an embodiment of the present invention. The flowchart depicted in FIG. 3 illustrates some of the functionality of GSC management tool 112 and should be read with reference to FIG. 1.

The example method begins at step 300 where a request for assistance on a contract is received from requestor 103a. As indicated above in conjunction with FIG. 2, this may be received via a contract assistance request form that is presented to requestor 103a on the screen of their personal computer in any suitable format. Management tool 112 automatically associates a request number with the request, as indicated by step 302. Request may then be stored in central repository 114, as indicated by request 120. Request 120 is also automatically placed in a worklist of requestor 103a so that they may keep track of the requests they have submitted. Management tool 112 also automatically notifies a contract lead of request 120, as indicated by step 304. This automatic notification may be accomplished via email or other suitable methods.

After contract lead 103d reviews request 120, they designate a negotiator 103b to handle request 120. This designation is received by management tool 112, as indicated by step 306, via any suitable method, such as selecting a particular negotiator from a pull-down list. Management tool 112 then automatically associates a record number with request 120 to establish a record 122 that may be stored in central repository 114. The record number and request numbers are automatically linked by management tool 112 so that requester 103a may be informed as to the status of their particular request, as indicated by step 312.

Record 122 is automatically placed in a worklist for negotiator 103b by management tool 112, as indicated by step 314. The negotiator 103b is also automatically notified that they have been assigned record 122, as indicated by 316. This automatic notification may also be by email or other suitable communication. A worklist for requester 103a may also be automatically updated, as indicated by step 318, in order to keep requester 103a informed as to their request. This may or may not include the linking of the record number with the request number, as indicated above in conjunction with step 312. Requestor 103a is automatically notified of the designated negotiator by management tool 112, as indicated by step 320. This automatic notification may also be by email or other suitable communication. Request 120 and record 122 are both stored in central repository 114, as indicated by step 322. This then ends the example method as outlined in FIG. 3.

FIG. 4 is a flowchart illustrating an example method of managing supplier contracts in accordance with another embodiment of the present invention. The example method outlined in FIG. 4 illustrates some additional functionality of GSC management tool 112 and should be read with reference to FIG. 1.

The example method begins at step 400 where a search request for record 122 is received from negotiator 103b. In one embodiment, negotiator 103b simply enters supplier contract management system 100 and selects a particular record from his or her worklist in order to access record 122. Thus, record 122 is retrieved from central repository 114 for selection by negotiator 103b, as indicated by step 402. The record may not only be associated with the worklist of negotiator 103b but also may be associated with a team worklist that negotiator 103b is a member of. This depends upon how the organization that is utilizing supplier contract management system 100 is set up from an organizational standpoint.

Data related to record 122 is received from negotiator 103b, as indicated by step 404. As indicated above in conjunction with FIG. 2, this data may include such things as general information, supplier information, company contact information, terms and conditions, and other suitable information. Activities related to record 122 may also be received, as indicated by step 406. These activities may be received by negotiator 103b or other suitable employees 103 that know about a particular event or happening regarding record 122. When record 122 has been completed, negotiator 103b indicates a completed status for record 122 and such indication is received by management tool 112, as indicated by step 408. Record 122 is then updated in central repository 114, as indicated by step 410, to indicate a completed contract. Record 122 is then automatically removed by management tool 112, as indicated by step 412, from the worklist of negotiator 103b based on this completed status.

The method continues at step 414 where a search request for record 122 is received from administrator 103c. Record 122 is retrieved from central repository 114, as indicated by 416, for selection by administrator 103c. Original documentation may be received by administrator 103c to support the on-line record. As indicated above, the record may be associated with a personal worklist of administrator 103c and administrator 103c simply selects the particular record from their worklist. Record 122 may also be associated with a team worklist, as indicated above for negotiator 103b. A contract number for record 122 is received from administrator 103c, as indicated by step 418, which indicates record 122 is satisfactory to administrator 103c. An active status for record 122 is received, as indicated by step 420, from administrator 103c to designate an active contract, which then automatically links the contract number with the record number by management tool 112, as indicated by step 422. Record 122 is then updated in central repository 114 to indicate an active contract, as indicated by step 424.

A scanned hard copy of record 122 (which in this embodiment is assumed to be a completed contract) is received by management tool 112 to create an electronic image of the completed contract, as indicated by step 426. This electronic image is then stored in contract database 116, as indicated by step 428. This allows images of all contracts to be viewed by employees 103 of the organization on a substantially real-time basis. Thus, employees may know when a particular contract has expired, or may know of particular obligations that their company may have on a particular contract with a supplier. Active contracts may also be linked together in a parent-child format. For example, the parent could be a Master Agreement, while Exhibits or Addendums could be its children.

Record 122 is automatically linked with the electronic image by management tool 112, as indicated by step 430, and record 122 is automatically removed from the worklist of administrator 103c, as indicated by step 432. This then ends the example method outlined in FIG. 4.

Thus, embodiments of the present invention provide an advantage to large business organizations that have a large number of suppliers. The organization may have a central repository that houses supplier data, information of all the past and current supplier contracts, and supplier contracts currently being negotiated. Employees in the organization may access this information through a company intranet or other suitable network in order to gain valuable information on a timely basis so that problems may be avoided, such as duplicity of effort, conflicts of interest, and the like. Up-to-date information on suppliers, current supplier contracts, and pending supplier contracts, may be accessed on a substantially real-time basis to help employees of a company be more efficient and cost-effective in their jobs, which hopefully pads the bottom line for the company. In addition, archived contracts may assist with resolving supplier disputes. View only access is also available for users to view anything in the database but not edit. A database administrator may also have access to special database maintenance.

Although an embodiment of the invention and its advantages are described in detail, a person skilled in the art could make various alternations, additions, and omissions without departing from the spirit and scope of the present invention as defined by the appended claims.

What is claimed is:

1. A method of managing supplier contracts, comprising:
receiving a request for assistance on a contract from a requestor, the request including a plurality of data;
automatically associating a request number with the request;
automatically notifying, based on at least some of the data, a contract lead of the request;
receiving, from the contract lead, a designation of a negotiator for the request;
automatically associating a record number with the request to establish a record;
automatically placing the record in a worklist for the negotiator;
automatically notifying the negotiator of the record; and
automatically notifying the requestor of the designated negotiator.

2. The method of claim 1, wherein the contract is a non-disclosure agreement.

3. The method of claim 1, further comprising storing the request and the record in a central repository.

4. The method of claim 3, further comprising automatically linking the record number with the request number.

5. The method of claim 1, wherein automatically notifying comprises electronic mailing.

6. The method of claim 1, further comprising:
the contract lead manually analyzing the request; and
manually designating the negotiator for the request.

7. The method of claim 1, further comprising receiving, from the contract lead, a designation of an administrator for the record.

8. The method of claim 1, further comprising automatically updating a worklist for the requestor.

9. The method of claim 1, further comprising:
receiving a status for the record from the negotiator; and
updating the record with the status.

10. The method of claim 9, wherein the status is selected from the group consisting of assigned, in progress, on hold, canceled, completed, in dispute, and satisfied.

11. The method of claim 1, further comprising:
receiving a search request for one or more completed contracts for a supplier from the requester; and
retrieving and displaying the completed contracts from a contract database for selection by the requestor.

12. The method of claim 1, wherein the plurality of data is retrieved from historical data associated with a prior request.

13. Software for managing supplier contracts, the software being embodied in computer-readable media and, when executed, operable to:
receive a request for assistance on a contract from a requester, the request including a plurality of data;
automatically associate a request number with the request;
automatically notify, based on at least some of the data, a contract lead of the request;
receive, from the contract lead, a designation of a negotiator for the request;
automatically associate a record number with the request to establish a record;
automatically place the record in a worklist for the negotiator;
automatically notify the negotiator of the record; and
automatically notify the requestor of the designated negotiator.

14. The software of claim 13, further operable to store the request and the record in a central repository.

15. The software of claim 14, further operable to automatically link the record number with the request number.

16. The software of claim 13, wherein automatically notify comprises electronic mailing based on a predetermined set of criteria.

17. The software of claim 13, further operable to:
the contract lead manually analyzing the request; and
manually designating the negotiator for the request.

18. The software of claim 13, further operable to receive, from the contract lead, a designation of an administrator for the request.

19. The software of claim 13, further operable to automatically update a worklist for the requestor.

20. The software of claim 13, further operable to:
receive a status for the record from the negotiator; and
update the record with the status.

21. The software of claim 13, wherein the status is selected from the group consisting of in progress, on hold, canceled, completed, in dispute, satisfied, and active.

22. The software of claim 13, further operable to:
receive a search request for one or more completed contracts for a supplier from the requester; and
retrieve and display the completed contracts from a contract database for selection by the requestor.

23. The software of claim 13, further operable to retrieve historical data associated with a prior request.

24. A method of managing supplier contracts, comprising:
receiving a search request for a record from a negotiator;
retrieving the record from a central repository for selection by the negotiator;
receiving data from the negotiator related to the record;
receiving a completed status of the record from the negotiator;
updating the record in the central repository to indicate a completed contract;
automatically removing the record from a worklist of the negotiator based on the received completed status;
receiving a search request for the record from an administrator;
retrieving the record from the central repository for selection by the administrator;
receiving a contract number for the record from the administrator;
receiving an active status of the record from the administrator to designate an active contract;
linking the contract number with the record number; and
updating the record in the central repository to indicate an active contract.

25. The method of claim 24, further comprising:
scanning a hard copy of the record that is indicative of the completed contract to create an electronic image of the completed contract; and
storing the electronic image in a contract database.

26. The method of claim 25, further comprising automatically creating a document cover sheet to link the record with the electronic image.

27. The method of claim 24, wherein the record is associated with a negotiator worklist.

28. The method of claim 24, further comprising automatically removing the record from a worklist of the administrator, and storing the record in a database.

29. The method of claim 24, further comprising changing the negotiator assigned to the record.

30. The method of claim 24, further comprising:
receiving a search request for one or more active contracts for a supplier from the negotiator or administrator; and
retrieving and displaying the active contracts from a contract database for selection by the negotiator or administrator.

31. The method of claim 24, further comprising:
receiving a search request for an employee; and
retrieving and displaying one or more employees based on the search request

32. The method of claim 31, wherein the employee is selected from the group consisting of an administrator, a contract lead, a negotiator, a requester, an attorney, and a buyer.

33. The method of claim 24, further comprising receiving an activity related to the record.

34. The method of claim 33, wherein the activity is received from the negotiator or the administrator.

35. Software for managing supplier contracts, the software being embodied in computer-readable media and, when executed, operable to:
receive a search request for a record from a negotiator;
retrieve the record from a central repository for selection by the negotiator;
receive data from the negotiator related to the record;
receive a completed status of the record from the negotiator;
update the record in the central repository to indicate a completed contract;
automatically remove the record from a worklist of the negotiator based on the received completed status;
receive a search request for the record from an administrator;
retrieve the record from the central repository for selection by the administrator;
receive a contract number for the record from the administrator;
receive an active status of the record from the administrator to designate an active contract;
link the contract number with the record number; and
update the record in the central repository to indicate an active contract.

36. The software of claim 35, further operable to:
create an electronic image of the completed contract; and
store the electronic image in a contract database.

37. The software of claim 36, further operable to create a document cover sheet to automatically link the record with the electronic image.

38. The software of claim 35, wherein the record is associated with a negotiator worklist.

39. The software of claim 35, further operable to automatically remove the record from a worklist of the administrator.

40. The software of claim 35, further operable to change the negotiator assigned to the record.

41. The software of claim 35, further operable to:
receive a search request for one or more active contracts for a supplier from the negotiator or administrator; and
retrieve and display the active contracts from a contract database for selection by the negotiator or administrator.

42. The software of claim 35, further operable to:
receive a search request for an employee; and
retrieve and display one or more employees based on the search request

43. The software of claim 31, wherein the employee is selected from the group consisting of an administrator, a contract lead, a negotiator, a requestor, an attorney, and a buyer.

44. The software of claim 35, further operable to receive an activity related to the record.
